(19) United States
(12) Patent Application Publication
(10) Pub. No.: US 2006/0031261 A1
(43) Pub. Date: Feb. 9, 2006

(54) System and Method for Preserving and Displaying Physical Attributes in a Document Imaging System

(75) Inventor: Adam Edwin Behringer, Issaquah, WA (US)

Correspondence Address: BLACK LOWE & GRAHAM, PLLC, 701 FIFTH AVENUE, SUITE 4800, SEATTLE, WA, 98104, US

(73) Assignee: BEE DOCUMENT INC., Issaquah, WA (US)

(21) Appl. No.: 10/710,812

(22) Filed: Aug. 4, 2004

(51) Int. Cl. G06F 17/30

(52) U.S. Cl. 707/200; 707/3

(57) ABSTRACT

A system, method, and user interface that allows one to easily navigate a document hierarchy. Document groups are represented graphically with an icon that represents the group type. The icons represent preserved physical attributes of the physical original documents. The icons are dynamically generated based on the preserved physical attribute information. The preserved physical attribute information is initially stored within delimited text values that are stored in a filename but may also be extracted from the filename for storage or use in other data structures. When a document group is selected, the contents (subgroups, documents, etc.) are presented to a user.

### FIELD OF THE INVENTION

This invention relates generally to document processing and, more specifically, to document storage and retrieval systems and methods.

### BACKGROUND OF THE INVENTION

Software systems are becoming increasingly more powerful and practical for the organization of large amounts of digital information. This has encouraged inventions in the areas of graphic user interfaces and search engines to organize that information. Because of the increases in efficiency that these technologies have caused, businesses, organizations and individuals are, in increasing measure, looking to convert their physical documents into digital documents (“imaging”) so that they can take advantage of the efficiencies and technologies that are uniquely available to digital information.

Unfortunately, physical documents contain much information that is lost when converting them to digital files using current technologies. Particularly when it comes to the organization of physical documents, there are many visual cues that help the observer quickly understand the scope and type of documents they are observing as well as providing clues which help the observer find a document that they need to access.

For example, a bookshelf in an office may contain several 3-ring binders, a stack of loose pages, a video tape, and several bound books. The type of physical containers (e.g., books, binders, video cassettes, etc.) provides clues to the observer about the contents of the document set (i.e., the contents of the physical container or information stored on the physical container). The observer will likely assume that information in a bound book is well organized and relatively complete. A loose stack of papers, by contrast, is more likely to be a work in progress that is not well sorted. It is assumed that the video tape will store information which can be realized as moving video with audio, and that binders will contain mostly paper based documents. Furthermore, if the observer is familiar with this particular bookshelf, they may quickly identify that the thin red binder with a few pages contains the documents of interest, rather than the thicker black binder with many pages. Within each binder, there may be tabs dividing a set of document into smaller sets of documents. Within the tabs, there may be documents stapled together. All of these visual clues, which may or may not be accompanied by text labels, provide important assumptions and memory associations that help with document navigation.

In the digital world, documents are stored as files, which contain contents (“data”) and file attributes (“meta-data”). Examples of meta-data are the name of the file, date at which the file was last modified, and the creator of the file. To organize the documents, software systems often employ a graphical user interface (GUI) with a folder hierarchy. In existing GUI's, folders all appear identical, or may contain customized icons to identify contents (such as the “My Photos” folder in Windows). The custom folder icons are not dynamic, meaning that they do not change to visually depict the attributes of the folder, and they are not preserved when migrating from one software system to another. A second common method to access digital documents is through an automated search of file contents or meta-data.

In an imaging workflow, documents are often imaged from a variety of sources using a variety of software tools. For example, an office may image some documents themselves and send others to a service provider. It is likely that the service provider is using different equipment and software than the office. Thus, a wide variety of imaging systems is needed. The problem also exists when the files are being viewed. Users may be accessing the files from a local storage location (such as a hard drive), or may access the files over a network. There have been varieties of software applications created (including operating systems) which allow for the organization and access of digital files. Thus, the physical attributes of the document set are not observable on a wide variety of software systems.

Therefore, there exists a need to preserve and derive value from the physical attributes of the document sets when documents are transformed from physical to digital media. This includes preserving the physical attributes across a variety of software systems including those software systems, which are accessible via a network.

### SUMMARY OF THE INVENTION

The present invention preserves and uses physical document attributes when the attributes are transferred to a digital media. Examples of preserved physical attributes include:
binding or container type (i.e. staple, binder, cd-rom, video tape)
color and pattern (i.e. red, black, green)
size (4″×5″, 8.5″×11″)
text label (“2004 receipts”, “personal files”, “wedding video”)
position within a physical hierarchy (i.e. a page, in a binder, in a box).

The present invention includes a user interface that allows one to easily navigate a document hierarchy over a network connection. Document groups are represented graphically with an icon that represents the group type. Other relevant data may be displayed next to the icon. The icons may represent the preserved physical attributes of the physical originals. The icons may be dynamically generated based on the preserved physical attribute information. The preserved physical attribute information is included within filenames that are stored in formats other than in a filename storage location. When a document group is selected, the contents (subgroups, documents, etc.) are presented to a user.

The present invention is independent of a particular software platform. Filenames are parsed and stored in a database or in a structured text file to allow browsing or searching by various software systems that can display the contained file formats.

### BRIEF DESCRIPTION OF THE DRAWINGS

The preferred and alternative embodiments of the present invention are described in detail below with reference to the following drawings.

FIG. 1 is a diagram of an example system for implementing the present invention; and

FIGS. 2-13 are screen shots of an exemplary user interface formed in accordance with an embodiment of the present invention.

### DETAILED DESCRIPTION OF THE INVENTION

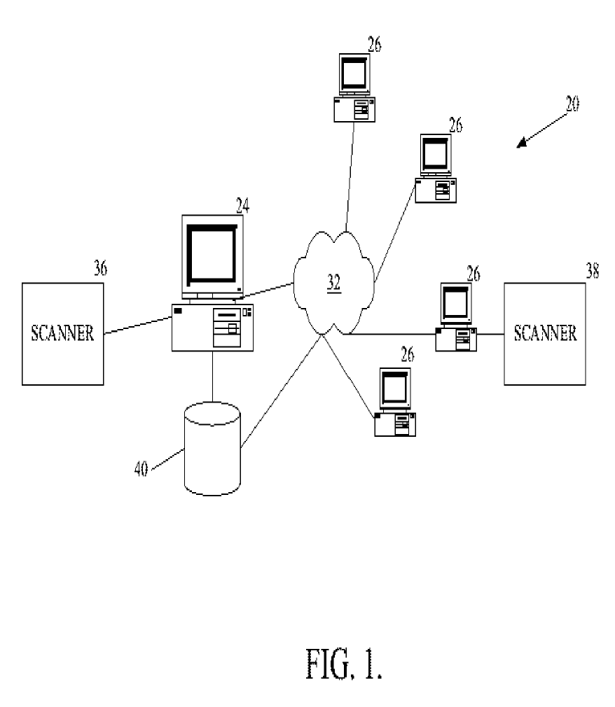

As shown in FIG. 1, a system 20 is illustrated that is one example system for implementing the present invention. The system 20 includes a document or host server 24 and a plurality of client computer devices 26 (e.g., personal computers, laptop computers, hand-held computers, or any other type of processor based device), coupled to a network 32, such as an Internet or the Internet.

A storage device 40 is in communication with the host server 24 or is in direct communication with the network 32. The storage device 40 stores documents that are accessible by users using the client computer devices 26. Also connected to the host server 24 is one or more scanners 36. The host server 24 may include a number of specialized servers, such as web, application, database, or imaging servers, on a number of different machines or work stations linked in an Internet or distributed across the network 32 or across another network (not shown).

It can be appreciated that the software application formed in accordance with the present invention can be implemented on stand-alone devices not connected to a network. For example, a laptop or on a copier include the storage, indexing, searching, and presentation capabilities provided by the present invention. The digitized documents and the graphical user interface for navigating through the stored documents are located and executed locally.

The operator or operators of the host server 24 maintains the storage of documents on the storage device 40 and adds or deletes the documents that are stored thereon. Users associated with the client computer devices 26 present the operator of the host server 24 with hard copies of documents that they wish to have accessible via one or more of the devices 26. The operator creates directories for the received documents and converts the received documents into digital format, by using the scanner 36 or some other digitizing means. The users may also pre-scan some or all of their documents using scanners 38 that are in communication with their associated device 26. The host server operator generates a user interface that is accessible by the devices 26 over the network 32. The user interface includes a directory of the documents that either the user supplied or is based on how the hard copies of the documents are stored in physical boxes, files, tabs, etc. The directory of the documents includes file and folder names that include physical attributes of the files, folders, or associated documents. The physical attributes are searchable. An example of the user interface is described in more detail below by example.

The documents that are scanned are saved as images in a hierarchical directory structure that matches the physical relationships of the documents as they were received. After the documents have been scanned and stored, the originals are returned to the users that sent the documents along with removable storage devices that include all the scanned images. The host server operator creates a case that references the stored documents using the data from the hierarchical directory structure.

A user (i.e., customer or client) gains access to the hierarchical directory structure and the associated images that are stored in the storage device 40 by first accessing a secure website hosted by the host server 24 and accessible via the associated client computer device 26 over the network 32. The users gain access to the information in the storage device 40 by entering a secure access code, password, or users' credentials that are analyzed by the host server 24 based on previously stored information. Once a user has gained access, the host server 24 downloads user interface software (such as a flash client or other autonomously executable software). In one embodiment, the user interface software requests the first three levels of hierarchy of the hierarchical directory structure (e.g., case, box, group).

After a user selects a level of the hierarchy (group) containing pages (images, movies, documents, etc.), information pertaining to the number of pages in the group as previously stored in the storage device 40 is used by the user interface software for generation of an associated dynamic icon. Other physical attribute information may be used by the interface software when generating the associated dynamic icon. Any selection by the user for a specific page or an image, the user interface software requests the associated document or image from the storage device 40 and presents it over the client computer device 26. The document or image retrieved and sent to the client computer device 26 can be converted and compressed as necessary in order to make an optimum experience for the user of the client computer device 26. The host server 24 may also process users' orders of hard copies. The hard copy orders are printed by an associated printer or are sent to a remote facility for printing. The printed documents are then mailed to the user who made the printing request. The host server 24 allows end-users to upload or change existing data with regard to documents or images, or other information associated with their account.

Capturing Physical Attributes

Images are saved on the file storage device 40 (such as a hard drive) that supports a hierarchy file structure (Windows, Macintosh, UNIX). A directory (or “folder”) is created on the file storage device for each document set. In one embodiment, the directories are arranged in a hierarchical pattern that matches the physical documents. For example, if there is a box that contains three binders, 4 directories are created. The first directory contains a directory representing the box. Within that “box” directory, there are three directories, each representing one of the binders. A filename is assigned to each directory. The filename includes physical attribute(s) of the physical contents of containers associated with each directory.

The physical attributes may be selected from a list of predefined values to record the value of the attribute. The following are some examples of predefined values for binding type, color, size, and label:

Binding Type—BINDER, STACK, CDROM, NEGATIVE, BOX, STAPLED, TAB

Color—RED, GREEN, YELLOW, WHITE, BROWN, BLACK, GREY20, GREY60

SIZE—4×5, 8_{—}5×11

Label—(label is not predefined)

The filenames of the directories that have been created to represent document sets (documents within a directory) include a list of these predefined values, corresponding to the physical attributes. The order of the attributes is predefined and is separated by a delimiter. For example, the order is defined as binding type, color, size, and label, and the delimiter is an asterisk (“*”) Here is a sample hierarchy using this structure:

BOX*BROWN**2004 Receipts

BINDER*BLACK*8_{—}5×11*Q1 Receipts
TAB**8_{—}5×11*January 2004
TAB**8_{—}5×11*February 2004
TAB**8_{—}5×11*March 2004
BINDER*BLACK*8_{—}5×11*Q2 Receipts
STACK*WHITE*8_{—}5×11*Unfiled

There may be document sets for which one or more of the attributes is not appropriate or available (such as the size of the box, or the color of the tabs in the example above). In those cases, the value is left blank. The delimiters are still present so that it is clear that the value was left blank intentionally. These filenames are set using any software that is able to name directories and, in one embodiment, are set by an operator of the system 24.

After the directory structure is created and the filenames are set, the actual documents are converted to digital files (e.g. scanned) and saved to the appropriate directory. Because the information describing physical attributes has been restricted to the filenames of the directories, this directory structure with its digital files can be stored, distributed, or accessed using methods available to any directory structure stored on a file storage device. For example, a CD-ROM copy could be created, the directory structure could be transferred over the network 32, or directories could be navigated using an operating system on a client device 26.

Extracting Information from Filenames

The filenames are stored in the storage device 40 a number of different ways. One of the ways to store information is in a relational database (“database”). Databases are often desired when there are large amounts of information that need to be efficiently stored, manipulated, and accessed. There is often a text based or graphic user interface, as will be shown by example below, that allows data stored in the database to be filtered, sorted, searched, and displayed by users. Also, applications are often able to access the information contained in a database from across the network 32 (such as the Internet).

Another method of storing data in the storage device 40 is using a structured text file, such as XML. A structured text file can store the same information that a database stores but the text file stores the data in a text format in a predefined structure. A structured text file has the advantage of being compatible with a wide range of software systems and computer platforms. XML is a specific international standard for storing information in a structured text file. Other standards for structured text files could be used.

A computer application is used to extract the information from the filenames that were created and store the extracted information in a database or structured text file. The computer application traverses the created directories structure and each time a directory is encountered, the computer application: a) adds a new document set to the database or structured text file (“destination”); b) extracts the filename from a source directory, c) separates the filename into components using the delimited; d) sets the attributes of the destination document set based on each component found in the filename.

When a file representing a document is encountered, the information regarding the document is also added to the database or structured text file with a link or file descriptor that points from the document information to the document itself. Note that the database or structure text may use different predefined keywords to represent the physical attributes that the filenames do, so the parsing application is able to translate the values from the filename to the new structure in which the data will be stored.

In addition to recording the information from the filename into a new data source, the parsing application also preserves the hierarchical structure of the document sets. This is often done by creating a parent attribute for each document that points to the document set encompassing it.

Applications transform data between any of the data sources. For example, an application translates the data in the database to a structured text file or vice-versa. Also, an application extracts data from the database or structured text file and recreates the directory structure. These transformations allow the physical attribute data to be used in a wide variety of applications and allows the entire system to remain modular, meaning that different pieces of the system can be upgraded without lessening the advantages of the other parts.

Display of Physical Attributes in GUI

A first way to navigate through the digital files is with a graphic user interface (GUI). Another way to navigate is with a search engine.

File hierarchies are displayed numerous ways on the computer system 26, such as indenting, double-click to display contents, vertical columns. In order to graphically display the physical attributes of a document set, the systems 24 or 26 supports dynamic icons. Dynamic icons are graphical objects displayed on a digital display device for representing an object or action. Dynamic icons are used to represent documents or sets of documents. The present invention introduces the concept of dynamic icons that are used to display the physical characteristics of a document set. A dynamic icon is chosen or created by the GUI in order to visually depict the recorded attributes (e.g., color, size, and binding type). The dynamic icons are created or chosen to approximate the visual aspects of the original physical document set. For example, a physical book that was red, is represented with an icon that appears as a red book.

The number of documents contained in a document set can be included in the physical attributes. The number of documents of the document set can be displayed with the dynamic icon. For example, a binder of documents that contains 400 pages could be displayed as thicker, or more full, than a binder containing 50 documents. This presents additional useful information to the user in a way that can be intuitively understood at a glance.

One technique for obtaining dynamic icons is to store a collection of icons that comprise all the possible combinations of recorded attributes. When the GUI needs to display a document set, it will seek information from the data source on that set's attributes and then select the stored icon that most closely represents that attribute.

Another technique dynamically generates the dynamic icon in real time. The GUI draws an icon using a set of drawing rules and the information provided from the data source. An example of this is a box that can be different sizes. The GUI uses geometric calculations to draw a box on screen that was the proper size as well as color.

In another embodiment, the GUI stores basic images to use as icons but could modify those basic images, based on the physical attributes, before the icons are displayed. For example, a photograph of a binder is used as an icon. That photograph is manipulated to appear in a specific color before it is displayed.

Components of software systems are sometimes spread over different machines in the network 32. For example, there may be a GUI component that runs on a client computer device 26 and a component that runs on the host server 24. The dynamic icons may be stored or created with the most efficient component of the system 20. For example, if the network 32 is slow, it may be determined that creating an icon on the client computer device 26 is more efficient than transferring it from the server 24. Conversely, the server 24 may have a faster processor than the client computer device 26, so the icon may be generated on the server 24 and then transferred to the client computer device 26.

Searching Based on Physical Attributes

Searching of the data stored on the storage device 40 can be performed using any of a number of user interfaces, such as graphic, text, and audio. A search query is formed by specifying through the user interface one or more attributes of the information being sought. The server 24 finds all the documents that match the search criteria and presents the found documents to the user via the client computer device 26.

Any data (such as the textual contents of a document) or meta-data (such as the date a document was saved) can be part of a search query. The present invention allows searching of the physical attributes along with all of the other meta-data.

Here are some examples of searches that are possible using physical attributes combined with other meta-data:
Show all documents in red binders from the box labeled “2004 receipts”
Search all film negatives created after Jan. 1, 2004

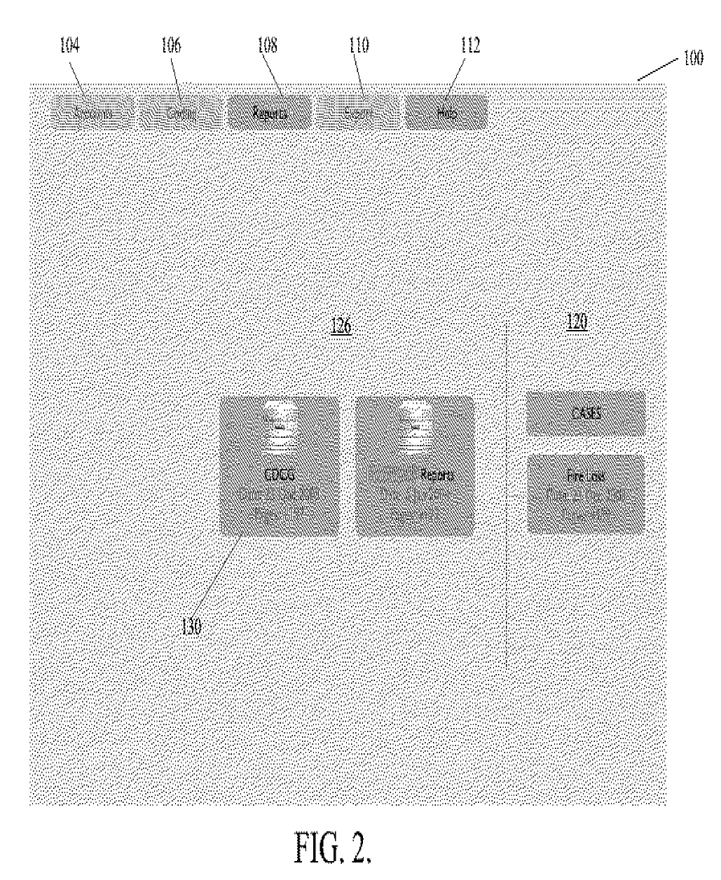

FIGS. 2-13 illustrate example web pages of a document storage and retrieval system supported by the server 24 and accessible by the device 26 over the network 32. FIG. 2 illustrates a web page 100 that is received by the client computer device 26 after the user associated with the client computer device 26 has successfully logged on to the service provided by the host server 24 over the network 32. The web page 100 is designed for implementation on a standard desktop or laptop computer, but could be reduced in size and usability for smaller display screens or converted to other output formats (such as sound, brail, etc). The web page 100 includes an Accounts button 104, a Coding button 106, a Reports button 108, an Export button 110, and a Help button 112. The buttons 104-112 are activated in a conventional manner with a keyboard, cursor control device or other type of user interface device. The web page 100 illustrates a default document navigation mode that appears after a user has logged onto to the service provided by the host server 24 over the network 32. The report section in this example shows a directory column 120 that identifies any cases associated with the user. In this example, one case appears (Fire Loss). Upon selection of the case Fire Loss, all of the boxes of documents associated with Fire Loss are displayed in a content display area 126 that is adjacent to the directory column 120.

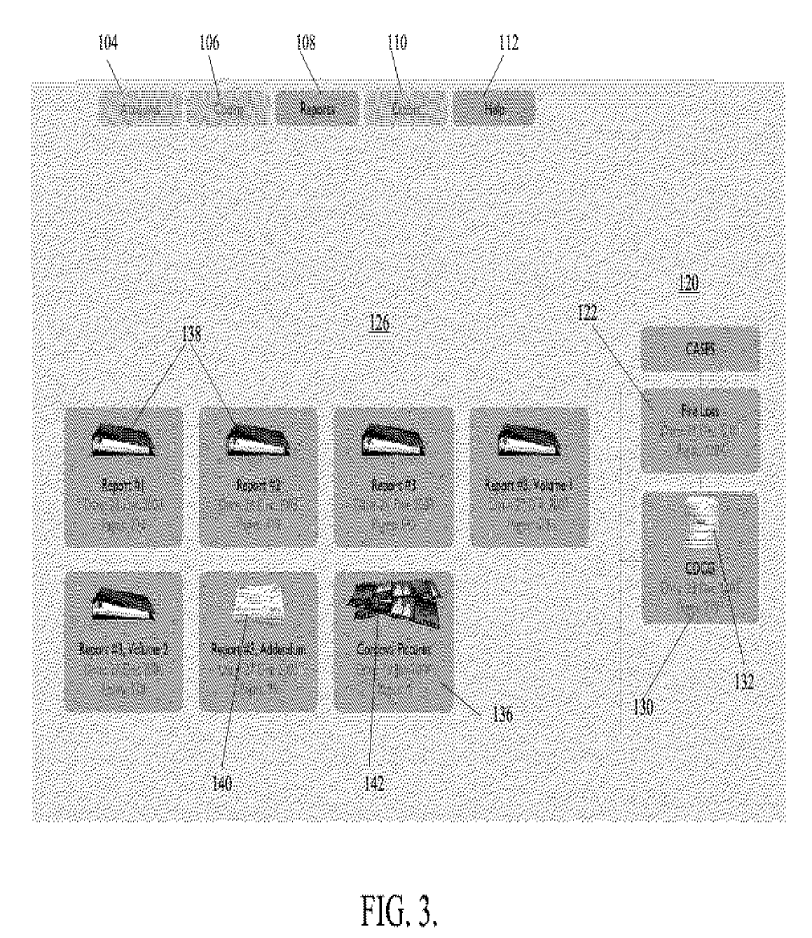

As shown in FIG. 3, the user has selected a box icon 130 that was presented in the area 126. Selection of the box icon 130 moves the box icon 130 into column 120 below the Fire Loss icon and presents all of the subfolders or tabs that were predefined to be included within the box icon 130 in the area 126.

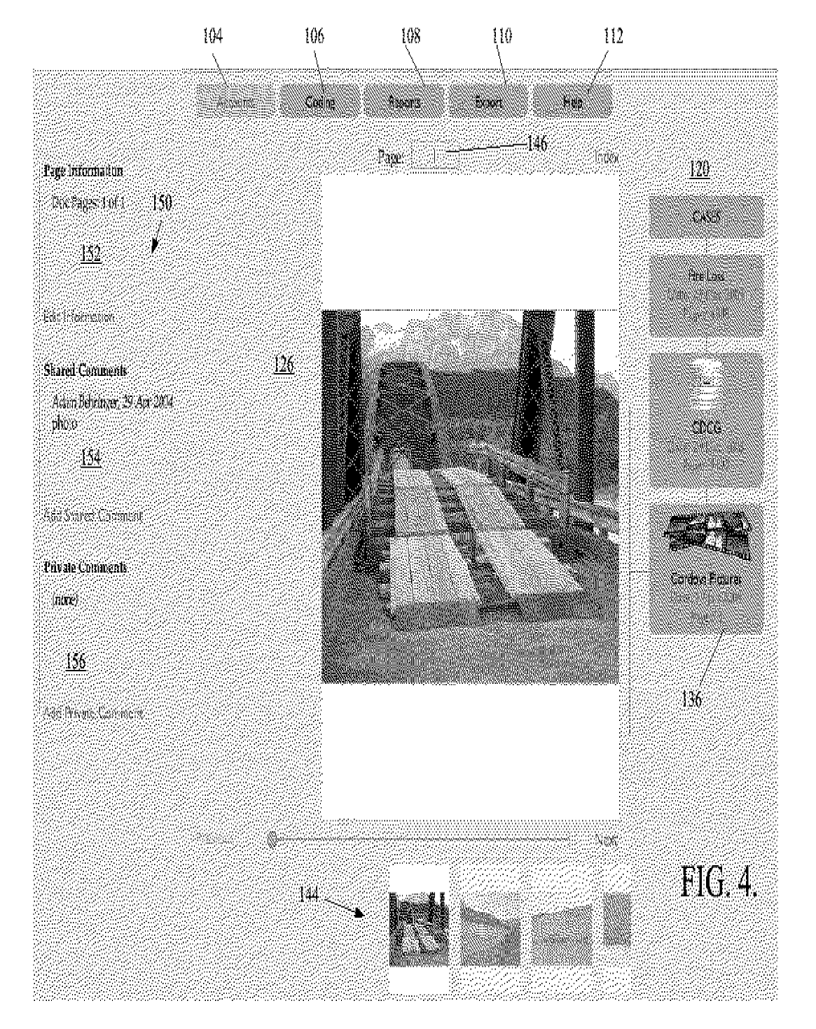

As shown in FIG. 4, the user has selected an icon 136 that includes Cordova pictures. Selection of the icon 136 moves the icon 136 into the column 120 and displays in the area 126 the first image stored in the directory location associated with the icon 136. Displayed below the area 126 is a thumbnail section 144 that presents the images that are included or associated with the icon 136. The section 144 includes a sliding bar with selectable previous and next hyperlink text that allows a user to view the images stored within the associated directory. A page number section 146 allows a user to enter a page number thereby causing the page associated with the entered page number to be presented in the area 126.

Adjacent to the area 126 is a page information section 150. The page information section 150 includes a page information section 152, a shared comments section 154, and a private comments section 156. Displayed in each of the sections 152-156 is information relating to each of those topics. The information displayed within the sections 152-156 is presented in different windows that are accessible by hyperlink text.

The icons 130 and 136 include various dynamic icons 132, 138, 140, and 142. In this example, the dynamic icons 132, 138, 140, and 142 include box icons 132, binder icons 138, paper document icons 140, and image icons 142. The icons 132, 138, 140, and 142 are dynamically displayed in a support icon 130 or 136 based on the stored filename information stored in the storage device 40.

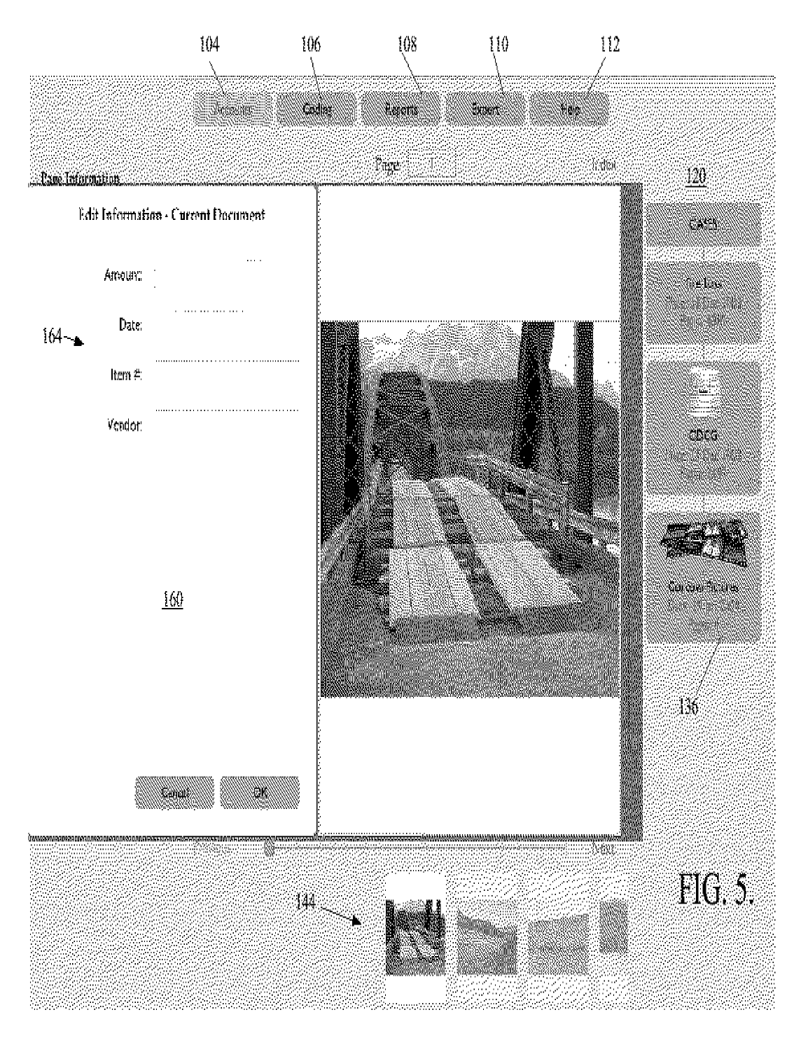

As shown in FIG. 5, the user has selected edit information text from the section 152 of FIG. 4 to present an edit information area 160. The edited information area 160 is presented adjacent to the corresponding displayed image and includes various editable fields 164, such as amount, date, item number, vendor. The area 160 also includes a cancel and okay button for canceling any entries or accepting any entries included in the fields 164. Information entered in the fields 164 and accepted are stored within the storage device 40.

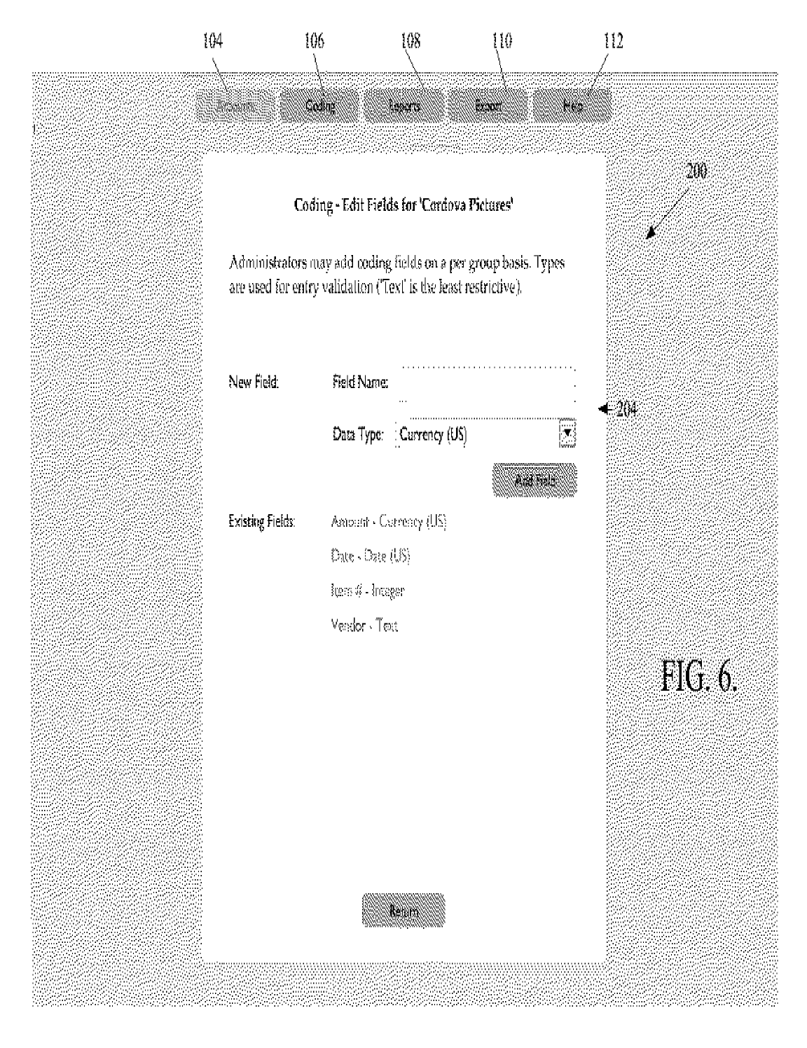

As shown in FIG. 6, a coding page 200 is displayed upon selection of the Coding button 106. An authorized user or administrator of the host server 24 uses the coding page 200 to add coding information into fields 204 on a per group basis. The fields that have been entered are presented in the edit information area 160.

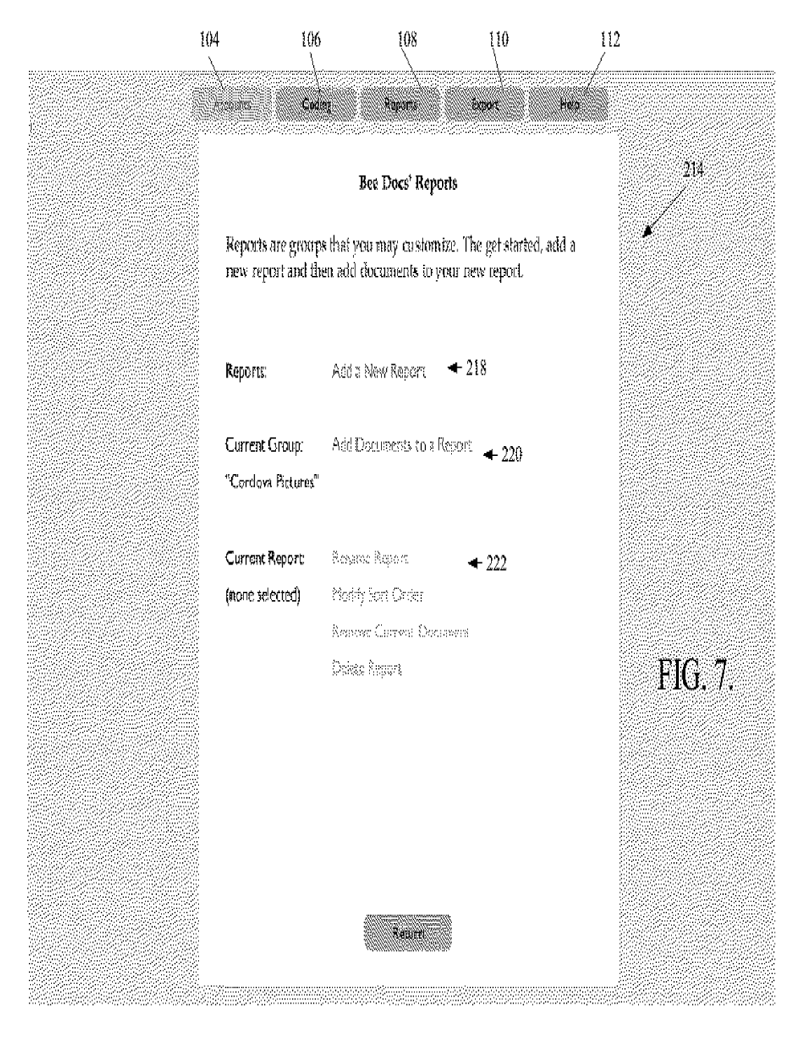

As shown in FIG. 7, a reports page 214 is displayed upon selection of the Reports button 108. Reports identified in the reports page 214 are customizable by the user. The reports page 214 includes an add a new report button or hyperlink 218 and an add documents to report button or hyperlink 220. When the user selects the new report button or hyperlink 218, a new report is created in the parent directory. User selection of the add documents a report button or hyperlink 220 adds documents from the current group (in this example, Cordova Pictures) to a user specified report. Also, the reports page 214 includes a report editing section 222 that allows a user to rename a selected report, modify sort order of the report, remove the current document, or delete the present report.

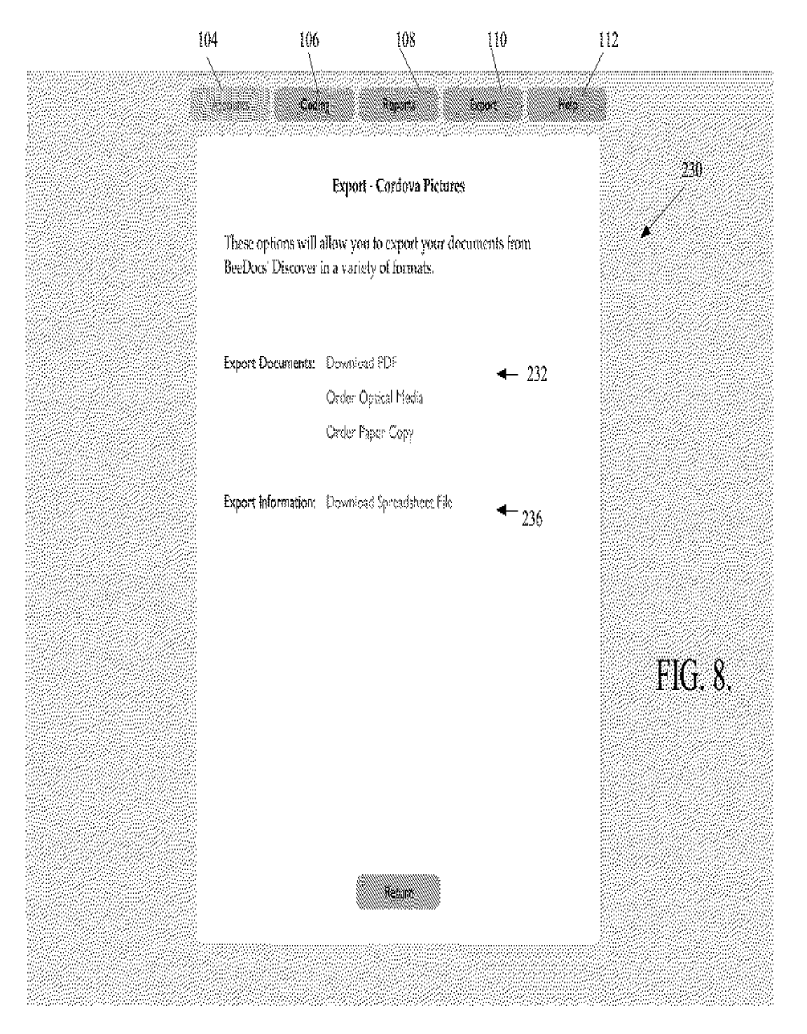

FIG. 8 illustrates a first export web page 230 that is presented upon selection of the Export button 110. User selection of the Export button 110 allows a user to retrieve electronic or hard copies of desired documents. The page 230 includes a selection list 232 that gives a user options for different ways in which they desire to download a document (e.g., download PDF, order optical media, order paper copy). An export information section 236 allows the user to select a spreadsheet file that is downloaded to their computer device 26.

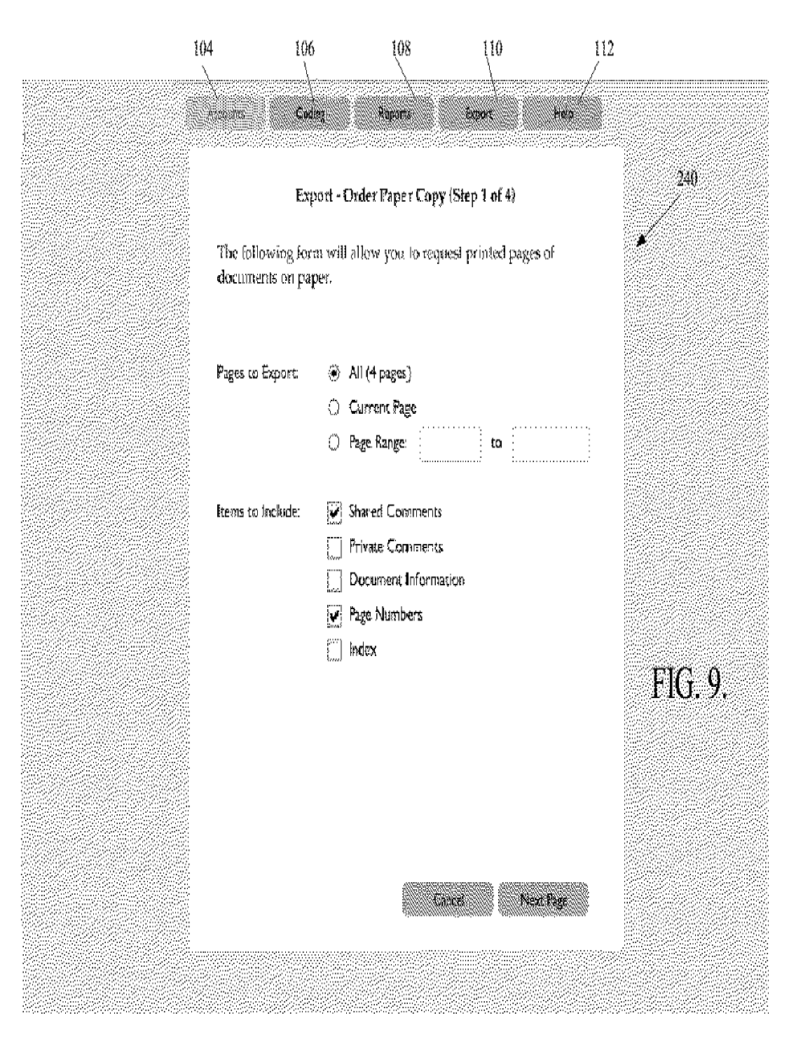

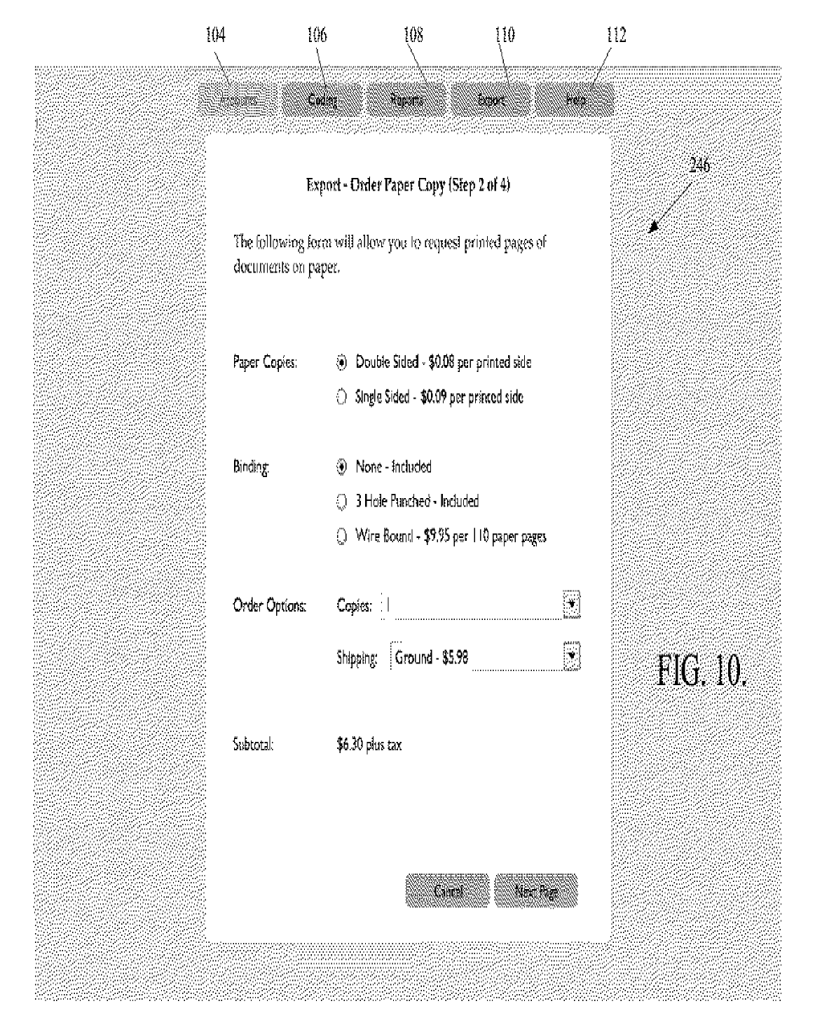

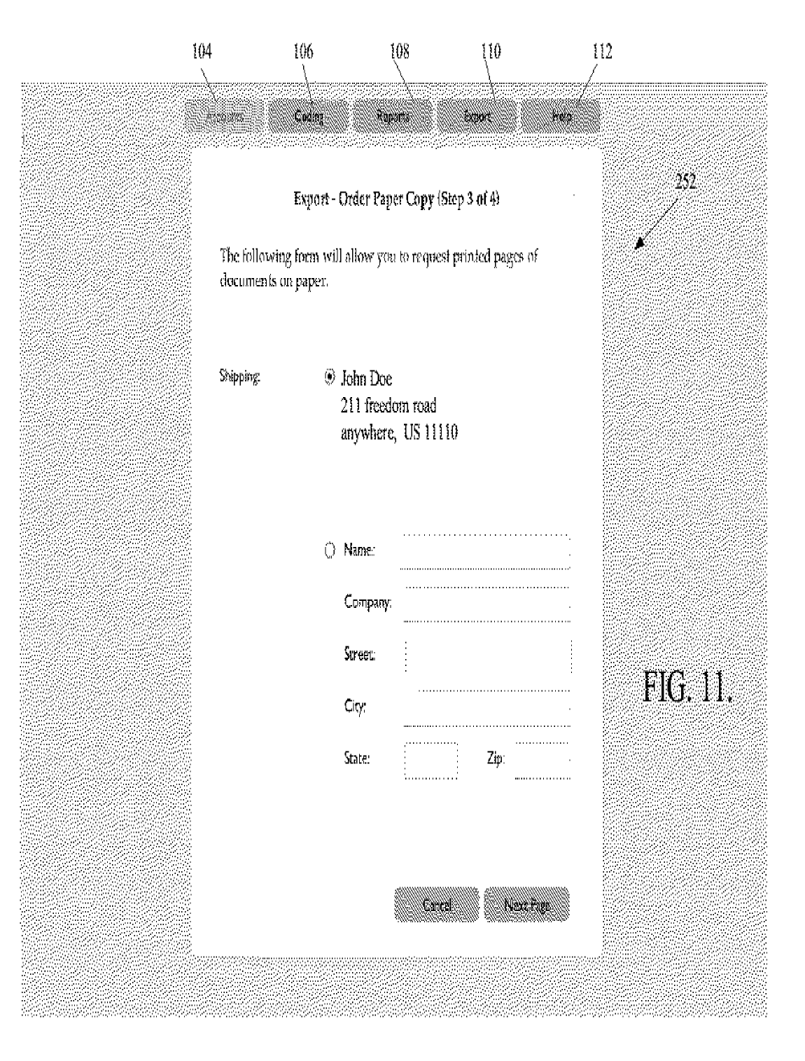

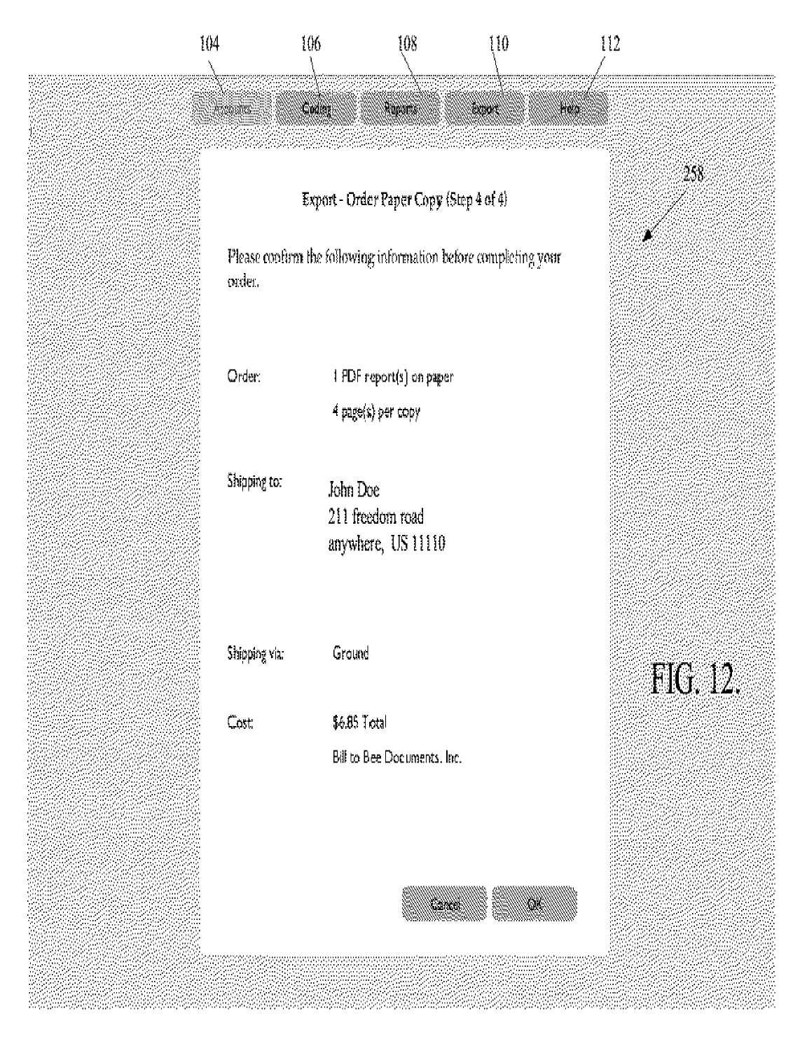

FIGS. 9-12 illustrate a series of web pages that a user progresses through upon selection of the order paper copy button or hyperlink shown in the section 232 of the export web page 230 (FIG. 8). Referring to FIG. 9, a first page 240 allows the user to select which pages to export (all pages, current page, range of pages). Also included within the first page 240 are items to be included with the ordered paper copy, such as shared comments, private comments, document information, page numbers, and index. After successful completion of the first page 240, the user selects a next page button and progresses to a second page 246 as shown in FIG. 10. The second page 246 includes printing options, such as selection of single or double-sided copies, type of binding (non, three-hole punched, wire-bound), order options (number of copies, type of shipping (both in pull-down selection list)). The cost of the selections made by the user are presented to the user dynamically on the second page 246. Upon successful completion of the second page 246, the user selects a next page button and progresses to a third page 252 as shown in FIG. 11. The third page 252 allows the user to confirm the shipping address or enter a new shipping address. Upon completion of the third page 252, the user selects a next page button and progresses to a fourth page 258 as shown in FIG. 12. The fourth page 258 presents all or most of the selections that the user selected previously, the type of shipping, and cost. After the user has reviewed and accepted all of the presented information on the fourth page 258, they select an okay button if the information is correct or a cancelled button to cancel the paper copy order.

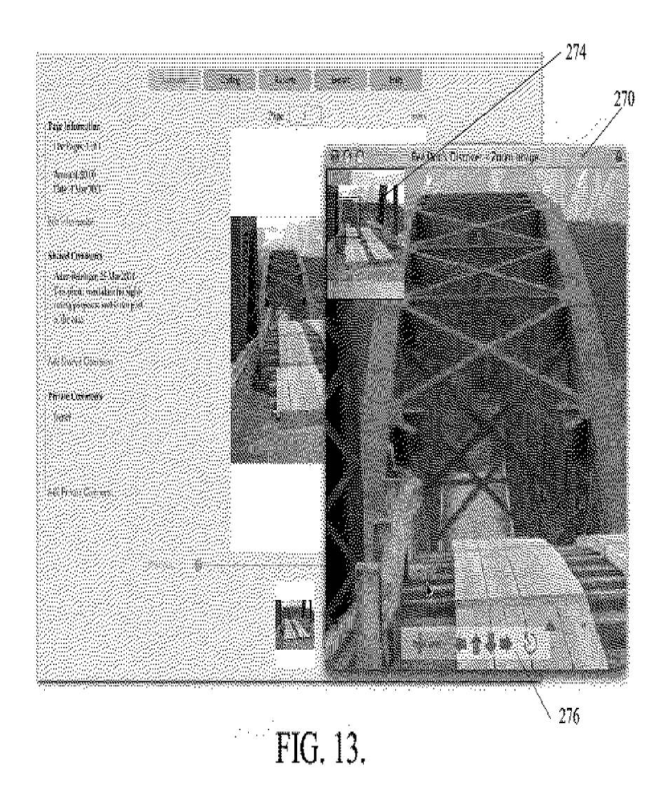

As shown in FIG. 13, an image pop-up window 270 appears upon a display image command generated by user activation of a cursor on an image displayed in the area 126 or selection of a display function from associated pull-down menus or other pop-up menus. The image pop-up window 270 includes image zoom and manipulation buttons 272 and an overall view window 274.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method comprising:
receiving a plurality of hard copy documents;
creating a digital hierarchical directory structure for representing the plurality of hard copy documents, wherein the digital hierarchical directory structure includes physical attribute information, physical attribute information being associated with at least one of the containers or the documents, physical attribute information includes a descriptor associated with one or more of the physical attributes of the associated container;
generating digital copies of each of the plurality of hard copy documents; and
storing the generated digital copies based on filenames associated with the physical attribute information,
wherein the received plurality of hard copy documents are received in one or more containers, each container having one or more actual physical attributes.

2. The method of claim 1, further comprising:
searching the digital hierarchical directory structure; and
retrieving one or more of the digital copies based on the search.

3. The method of claim 2, wherein searching includes searching physical attribute information using one or more actual container physical attribute.

4. The method of claim 1, further comprising:
transforming the digital hierarchical directory structure between two or more of a filenames storage format, a structured text format, or a relational database format.

5. The method of claim 1, wherein physical attribute information is stored in a filenames storage format, a structured text format, or a relational database format.

6. The method of claim 1, further comprising:
presenting one or more icons, each icon being associated with one of the containers.

7. The method of claim 6, wherein presenting includes dynamically presenting icons based on physical attribute information.

8. The method of claim 7, wherein dynamically presenting icons includes dynamically determining color of the icon based on information included within the physical attribute information.

9. The method of claim 7, wherein dynamically presenting icons includes dynamically determining icon size based on information included within the physical attribute information.

10. The method of claim 9, wherein the information included within the physical attribute information includes number of documents.

11. The method of claim 9, wherein the information included within the physical attribute information includes size of the associated container.

12. The method of claim 7, wherein dynamically presenting icons includes dynamically determining icon type based on information included within the physical attribute information.

13. A graphical user interface executed on a computer-based system having a digital storage device, the graphical user interface comprising:
a first area for presenting a selected source identifier component and all parent source identifier components of the selected source identifier component; and
a second area for presenting one or more of at least one source identifier component, one or more source identifier components associated with the selected source identifier component, or at least one image or document stored in the digital storage device, the at least one image or document being associated with the selected source identifier component,
wherein one or more of the source identifier components is associated with physical attribute information,
wherein the images, documents, and at least one of the source identifier components are associated with hard copies.

14. The interface of claim 13, wherein the source identifier components associated with physical attribute information include an icon, wherein the physical attribute information is based on containers that included hard copies of images and documents that are associated with images or documents stored in the digital storage device.

15. The interface of claim 14, further comprising:
a component for determining appearance of the icon based on the associated physical attribute information.

16. The interface of claim 15, wherein the component determines color of the icon.

17. The interface of claim 15, wherein the component determines icon size.

18. The interface of claim 17, wherein the physical attribute information includes number of documents in the source identifier component.

19. The interface of claim 17, wherein the physical attribute information includes size of the associated container.

20. The interface of claim 17, wherein the physical attribute information includes icon type information.

21. The interface of claim 13, wherein the physical attribute information is stored in one of a filenames storage format, a structured text format, or a relational database format.

22. A computer-based system comprising:
a storage device for storing digital copies of physical documents included in containers and a hierarchical directory structure for organizing the physical documents and associated containers, wherein the digital hierarchical directory structure includes physical attribute information, physical attribute information being associated with at least one of the containers or the documents, wherein the physical attribute information includes a descriptor associated with one or more of the physical attributes of at least one of the associated container or contents of the associated container;
a processor in communication with the storage device, the processor comprising:
a first component for generating a user interface that provides access to the digital hierarchical directory structure and stored digital copies of physical documents.

23. The system of claim 22, wherein the processor further comprises:
a second component for searching the digital hierarchical directory structure and presenting the results of the search.

24. The system of claim 22, wherein the second component searches physical attribute information stored in the digital hierarchical directory structure.

25. The system of claim 22, wherein the processor further comprises:
a second component for transforming the digital hierarchical directory structure between two or more of a filenames storage format, a structured text format, or a relational database format.

26. The system of claim 22, wherein the user interface includes one or more icons being associated with a portion of the physical attribute information.

27. The system of claim 26, wherein at least one of the one or more icons are dynamically presented based on information associated with the physical attribute information.

28. The system of claim 27, wherein one of the dynamically presented icons include dynamically determining color of the icon based on information included within the physical attribute information.

29. The system of claim 27, wherein one of the dynamically presented icons includes dynamically determining icon size based on information included within the physical attribute information.

30. The system of claim 29, wherein the information included within the physical attribute information includes number of documents included in the associated container.

31. The system of claim 29, wherein the information included within the physical attribute information includes size of the associated container.

32. The system of claim 27, wherein dynamically presenting icons includes dynamically determining icon type based on information included within the physical attribute information.

33. The system of claim 22, wherein the first component the generated user interface provides access to the digital hierarchical directory structure and stored digital copies of physical documents over the network.
